(19) United States
(12) Patent Application Publication
(10) Pub. No.: US 2023/0352761 A1
(43) Pub. Date: Nov. 2, 2023

(54) Method and Device for Thermal Control of Battery after Charging Based on Air Temperature Prediction

(71) Applicant: JIANGSU ZENERGY BATTERY TECHNOLOGIES CO., LTD., Changshu Suzhou City Jiangsu (CN)

(72) Inventor: Zhigang WANG, Changshu Suzhou City Jiangsu (CN)

(21) Appl. No.: 18/140,610

(22) Filed: Apr. 27, 2023

(30) Foreign Application Priority Data
Apr. 29, 2022 (CN) 202210464868.1

(51) Int. Cl. H01M 10/633; H01M 10/635; H01M 10/613; H01M 10/615

(52) U.S. Cl. CPC H01M 10/633; H01M 10/635; H01M 10/613; H01M 10/615

(57) ABSTRACT

The disclosure discloses a method and device for thermal control of a battery after charging based on air temperature prediction. In the method or device, a predicted air temperature of a local area is acquired via a network, contrast and comparison are performed according to the predicted air temperature and a current battery temperature, and the battery is periodically controlled to be heated or cooled in combination with the natural heat dissipation of a battery pack.

### TECHNICAL FIELD

The embodiments of the disclosure relate to thermal management of batteries of electric vehicles.

### BACKGROUND

Power supplies used by existing electric vehicles are usually lithium ion batteries. The lithium ion battery is relatively sensitive to temperature, excessively low and excessively high temperatures affect the lithium ion battery, or even seriously cause explosion, thus generating serious driving safety problems. Therefore, the lithium ion battery needs to be charged or discharged within a relatively reasonable working range. While the ambient air temperature changes with climate conditions, and thus it is difficult to maintain within the working temperature range of the lithium ion battery. To this end, many electric vehicles are provided with liquid cooling systems and heating systems for battery packs. When the temperature of the battery is excessively low, the temperature of the battery is increased by heating the battery via the heating system. When the temperature of the battery is excessively high, the temperature of the battery is reduced by cooling the battery via the liquid cooling system, so that the lithium ion battery may be kept within an optimal working temperature range as much as possible.

It usually takes a relatively long time to charge the battery of the electric vehicle. After the charging is completed, it's almost time to use the vehicle. There are also many cases where there is a certain time from the completion of the charging to the use of the vehicle. At this time, a battery management system generally provides two thermal management modes: the first mode is to directly turn off the thermal control of the battery, and the second mode is to turn on continuous thermal control of the battery. A user may set which mode to use according to real-time needs. In the first mode, the temperature of the battery returns to the ambient temperature depending on natural heat dissipation or heat absorption. If the ambient temperature is within the reasonable working range of the battery, the user can use the vehicle at any time. If the ambient temperature is excessively low, when the user uses the vehicle, and the temperature of the battery returns to the ambient temperature, at this time, the user needs to wait for heating the battery until the temperature of the battery may be within the normal working range. That is, in this mode, the user may not be able to use the vehicle at any time. In the second mode, the thermal control of the battery enables the battery to remain within a suitable working temperature range, whereby the user may use the vehicle at any time. However, a large amount of electrical energy needs to be consumed for heating and cooling the battery.

### SUMMARY

A method for thermal control of a battery after charging based on air temperature prediction according to the present invention includes the following steps:
step S1: acquiring a current battery temperature;
step S2: judging whether the current battery temperature is within an optimal working temperature section; in response to that the current battery temperature is not within the optimal working temperature section, controlling a heating system to heat the battery or controlling a cooling system to cool the battery, and otherwise, executing step S3;
step S3: acquiring a predicted air temperature of a local area via a network;
step S4: in response to that the predicted air temperature is within a normal working temperature section, stopping heating or cooling the battery, and otherwise, calculating a duration t required for the battery temperature to reach a target battery temperature from the current battery temperature in a natural heat dissipation or heat absorption state to satisfy, wherein a temperature difference between the target battery temperature and the predicted air temperature being less than Th, Th represents a preset temperature threshold value, an upper limit of the normal working temperature section is greater than an upper limit of the optimal working temperature section, and a lower limit of the normal working temperature section is less than a lower limit of the optimal working temperature section;
step S5: in response to that t<t0, stopping heating or cooling the battery, and otherwise, heating or cooling the battery;
wherein, t0 represents a preset time threshold value; and
step S6: repeatedly executing steps S1 to S5.

Alternatively, in the method for thermal control of the battery after charging based on air temperature prediction according to the embodiments of the disclosure, in the step S6, the steps S1 to S5 are repeatedly executed after waiting for a certain time interval.

Alternatively, in the method for thermal control of the battery after charging based on air temperature prediction according to the embodiments of the disclosure, in the step S6, the waiting time interval is t0.

Alternatively, in the method for thermal control of the battery after charging based on air temperature prediction according to the embodiments of the disclosure, in the step S4, the time t is calculated by using the following formula:

t=a×In(dT)+b; wherein,
t represents the time required for the battery temperature in the natural heat dissipation or heat absorption state to satisfy the temperature difference between the current battery temperature and the predicted air temperature being less than Th;

dT=abs(Te−Tc);
a and b represent pre-measured coefficients;
Tc represents the current battery temperature; and
Te represents the predicted air temperature.

Alternatively, in the method for thermal control of the battery after charging based on air temperature prediction according to the embodiments of the disclosure, in the step S3, the air temperature prediction data of the local area in the future N hours is acquired via the network, and then the predicted air temperature is obtained by calculating an average value of the air temperature prediction data.

A device for thermal control of a battery after charging based on air temperature prediction according to the present invention includes the following components:
a component M1, configured to acquire a current battery temperature;
a component M2, configured to judge whether the current battery temperature is within an optimal working temperature section; in response to that the current battery temperature is not within the optimal working temperature section, control a heating system to heat the battery or control a cooling system to cool the battery, and otherwise, execute a component M3;
the component M3, configured to acquire a predicted air temperature of a local area via a network;
a component M4, configured to in response to that the predicted air temperature is within a normal working temperature section, stop heating or cooling the battery, and otherwise, calculate a duration t required for the battery temperature to reach a target battery temperature from the current battery temperature in a natural heat dissipation or heat absorption state to satisfy, wherein a temperature difference between the target battery temperature and the predicted air temperature being less than Th, Th represents a preset temperature threshold value, an upper limit of the normal working temperature section is greater than an upper limit of the optimal working temperature section, and a lower limit of the normal working temperature section is less than a lower limit of the optimal working temperature section;
a component M5, configured to in response to that t<t0, stop heating or cooling the battery, and otherwise, heat or cool the battery;
wherein, t0 represents a preset time threshold value; and
a component M6, configured to repeatedly execute the components M1 to M5.

Alternatively, in the device for thermal control of the battery after charging based on air temperature prediction according to the embodiments of the disclosure, in the component M6, the components M1 to M5 are repeatedly executed after waiting for a certain time interval.

Alternatively, in the device for thermal control of the battery after charging based on air temperature prediction according to the embodiments of the disclosure, in the component M6, the waiting time interval is t0.

Alternatively, in the device for thermal control of the battery after charging based on air temperature prediction according to the embodiments of the disclosure, in the component M4, the time t is calculated by using the following formula:

t=a×In(dT)+b; wherein,

t represents the time required for the battery temperature in the natural heat dissipation or heat absorption state to satisfy the temperature difference between the current battery temperature and the predicted air temperature being less than Th;

dT=abs(Te−Tc);
a and b represent pre-measured coefficients;
Tc represents the current battery temperature; and
Te represents the predicted air temperature.

Alternatively, in the device for thermal control of the battery after charging based on air temperature prediction according to the embodiments of the disclosure, in the component M3, the air temperature prediction data of the local area in the future N hours is acquired via the network, and then the predicted air temperature is obtained by calculating an average value.

### BRIEF DESCRIPTION OF THE DRAWINGS

FIG. 1 is an overall flowchart of an embodiment of the disclosure.

FIG. 2 is a schematic diagram of a connecting structure of a battery management system involved in an embodiment of the disclosure.

FIG. 3 shows experimental data of a natural cooling time and a temperature difference of a certain battery pack.

### DETAILED DESCRIPTION OF THE EMBODIMENTS

The problems to be solved by the embodiments of the disclosure are to ensure that a user may use a vehicle at any time, and to reduce the energy consumption for heating and cooling a battery.

The embodiments of the disclosure will be further described in detail below with reference to the drawings.

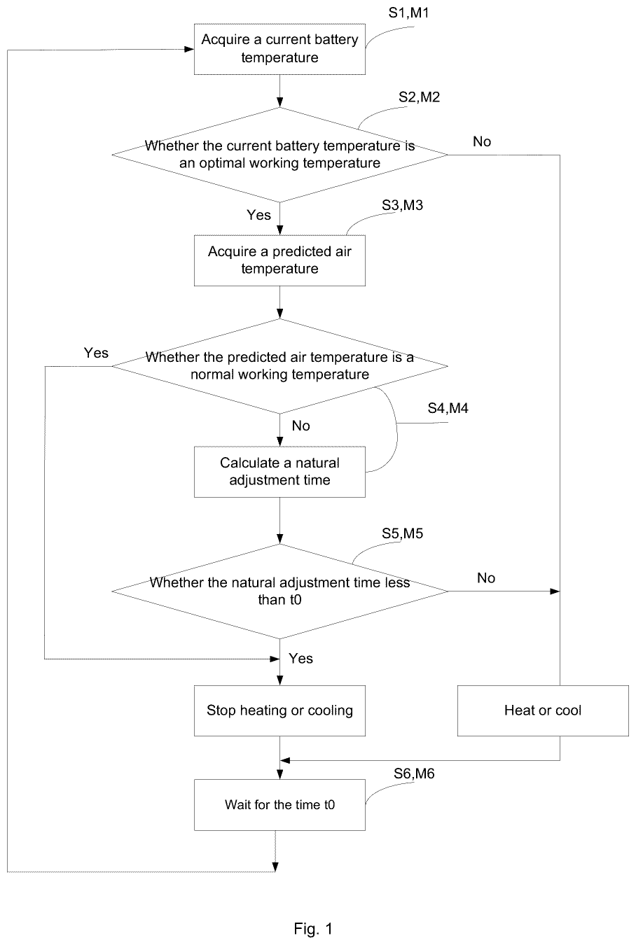

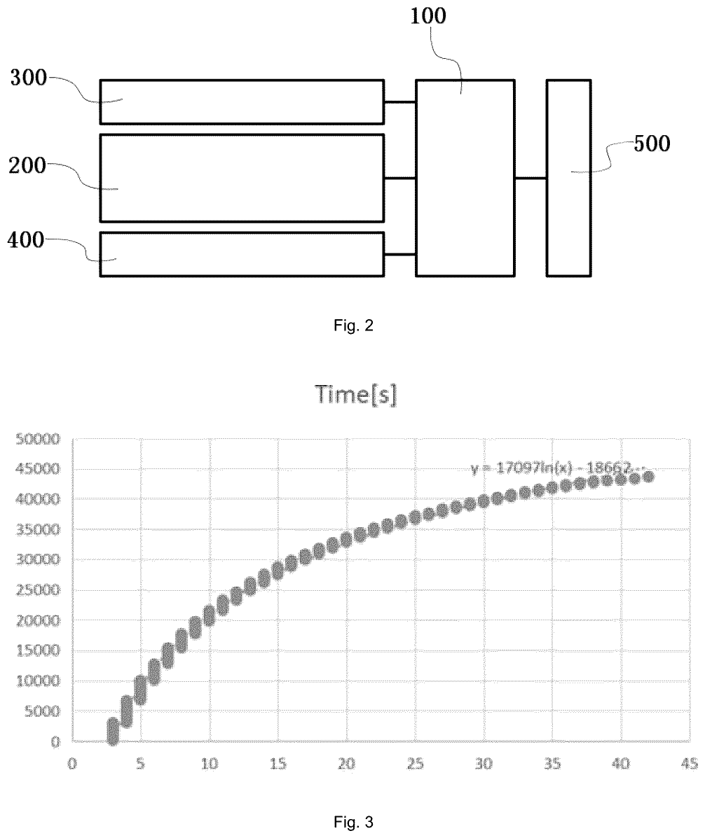

FIG. 2 illustrates a battery management system for an electric vehicle. The battery management system includes a processor 100, a battery array 200, a cooling system 300, a heating system 400 and a mobile communication module 500. The processor 100 is connected with the battery array 200, the cooling system 300, the heating system 400 and the mobile communication module 500. The battery array 200 is formed by connecting several batteries in a battery box. The cooling system 300 generally utilizes a liquid cooling mode for cooling the batteries in the battery array 200. The heating system 400 generally utilizes a PTC heating resistor for heating the batteries in the battery array 200. The mobile communication module 500 accesses a mobile network in a 2G/3G 4G 5G mobile communication mode, thereby connecting to the Internet, so as to access a website on the Internet. The processor 100 is generally a processor in a battery management unit in the battery box, and implements battery management by executing a computer program instruction set stored on a memory. A method for thermal control of a battery after charging based on air temperature prediction in the present embodiment is a method implemented by the processor 100 by means of executing the computer program instruction set. The method is a processing process when an electric vehicle is not used after the charging of the battery is completed, and the function of the method is to enable the battery to be kept at a suitable temperature, so that the user can use the vehicle at any time. Referring to FIG. 1, the method is a continuous cyclic processing process until the electric vehicle is used. When the electric vehicle is used, the battery enters a normal working state, and at this time, the thermal control management of the battery is processed by another processing process, which is not a scope discussed in the present invention. Referring to FIG. 1, the method specifically includes the following steps:
step S1: acquiring a current battery temperature;
step S2: judging that the current battery temperature is an optimal working temperature;
step S3: acquiring a predicted air temperature;
step S4: judging whether the predicted air temperature is a normal working temperature, and calculating a natural adjustment time;
step S5: judging whether the natural adjustment time is less than t0; and
step S6: repeatedly executing steps S1 to S5 after waiting for the time t0.

In step S1, after the battery temperature of each battery is collected in real time by means of a collection circuit, which is arranged on the battery array 200, an average value of the collected battery temperatures is used as the current battery temperature.

In step S2, the optimal working temperature may generally be expressed as a section, that is, an optimal working temperature section. Therefore, the step S2 may be expressed as judging whether the current battery temperature is in the optimal working temperature section. In response to that the current battery temperature is not within the optimal working temperature section, a heating system is controlled to heat the battery, or a cooling system is controlled to cool the battery, and otherwise, step S3 is executed.

In step S3, the predicted air temperature is acquired via a network, that is, the processor 100 is connected to a website on the Internet via the mobile communication module 500, and acquires air temperature prediction data on the website. In the present embodiment, the air temperature prediction data acquired on the website is the air temperature prediction data of a local area in the future N hours. The air temperature prediction data within the N hours is air temperature prediction data of N per hours. The predicted air temperature of the present embodiment is obtained after an average value is calculated. The value of N is 3-12.

In Step S4, the normal working temperature may generally be expressed as a section, that is, a normal working temperature section. In this way, the step S4 of judging whether the predicted air temperature is a normal working temperature may be expressed as judging whether the predicted air temperature is within the normal operating temperature section. In response to that the predicted air temperature is within the normal working temperature section, the heating or cooling is stopped, and otherwise, the natural adjustment time is calculated. The natural adjustment time refers to a time required for the battery temperature in a natural heat dissipation or heat absorption state to satisfy a temperature difference between the current battery temperature and the predicted air temperature being less than Th, and the time is expressed as t. In the present embodiment, the time t, that is, the natural adjustment time, is calculated by using the following formula:

t=a×In(dT)+b;
wherein, dT=abs(Te−Tc); a and b represent pre-measured coefficients; Tc represents the current battery temperature; Te represents the predicted air temperature; 1n represents a logarithmic function with a natural constant E as the bottom, and abs represents an absolute value.

According to common general knowledge, under natural cooling conditions, the amount of heat dissipated by an object within a unit time is in direct proportion to the temperature difference, which is expressed as a differential equation:

$$\frac{dQ}{dt} = k ( T - {T}_{0} ) ;$$

wherein, dQ and dt respectively represent differential forms of dissipated heat and time, k represents a conductivity coefficient, T represents the current temperature, and T₀ represents an ambient temperature.

Since the temperature change of the object is in direct proportion to the dissipated heat:

dT=−c*dQ;
wherein, c may be expressed as a specific heat capacity coefficient, and dT is a derivative form of the temperature of the object.

The two formulas are combined to obtain:

$$dt = \frac{dT}{- ck ( T - {T}_{0} )} .$$

In response to that T_{c}>Tₑ, T_{c} is used as an initial temperature, Tₑ+Th is used as an end temperature, T₀ is replaced with Tₑ for substitution, and integration is performed on both sides to obtain:

$$t = \int d t = {\int }_{{T}_{c}}^{{T}_{e} + T h} \frac{1}{- c ( T - {T}_{0} )} d T = \frac{1}{- c} ( ln ( Th ) - ln ( {T}_{c} - {T}_{e} ) ) ;$$

$$then :$$

$$t = a \times ln ( Tc - T e ) + b ,$$

$$wherein$$

$$a = \frac{1}{c k} , b = - \frac{ln ( Th )}{c k} .$$

In response to that Tc<Te, Tc is used as the initial temperature, Te−Th is used as the end temperature, T₀ is replaced with Te for substitution, and integration is performed on both sides to obtain:

$$t = \int dt = {\int }_{{T}_{c}}^{{T}_{e} - T} \frac{1}{- ck ( T - {T}_{0} )} dT = \frac{1}{- ck} ( ln ( Th ) - ln ( {T}_{e} - {T}_{c} ) ) then : \\ t = a \times ln ( Te - Tc ) + b , wherein , a = \frac{1}{ck} , b = - \frac{ln ( Th )}{ck} .$$

It can thus be seen that, regardless of Tc>Te or Tc<Te, there are forms: t=a×In(dT)+b, dT=abs(Te−Tc), and the coefficients a and b of the two formulas are the same. Therefore, it can also be seen that, the calculation formula of the natural adjustment time of the embodiments of the disclosure is derived from formula derivation. In the present embodiment, the coefficients a and b are obtained by actual measurement and then are stored in a memory. Those skilled in the art may understand that, the size, product structure and the thermal insulation design of each battery pack all affect the natural heat dissipation and heat absorption of the battery, thereby affecting the numerical values of the coefficients a and b. However, the size, structure and thermal insulation design of each different device may not be the same, therefore, the coefficients a and b may only be obtained by measurement.

In addition, according to the above formula, b/a=−In(Th), but the actual measurement result may have a relatively large difference from a theoretical value. For example, the relationship between a natural cooling time and the temperature difference measured for a specific battery pack is shown in FIG. 3. According to the experimental data shown in FIG. 3, when the value of Th is 10, the natural cooling time and the temperature difference are presented as a logarithmic curve, and the logarithmic curve is fitted to obtain a=17097, and b=−18662.

In addition, the normal working temperature section herein is a section that is greater than the optimal working temperature section range in step S2. Specifically, an upper limit of the normal working temperature section is greater than an upper limit of the optimal working temperature section, and a lower limit of the normal working temperature section is less than a lower limit of the optimal working temperature section. In the present embodiment, the optimal working temperature section is [Ta, Tb], and then the normal working temperature section is [Ta−Th, Tb+Th], or the normal working temperature section is [Ta, Tb], and the optimal working temperature section is [Ta+Th, Tb−Th]. That is to say, in the present embodiment, the upper limit of the normal working temperature section is Th greater than the upper limit of the optimal working temperature section, and the lower limit of the normal working temperature section is Th less than the lower limit of the optimal working temperature section. The Th herein is the threshold value Th defined in the natural adjustment time, and is optimally 10.

The step S5 specifically includes: in response to that t<t0, stopping heating or cooling the battery, and otherwise, heating or cooling the battery.

Step S6 indicates that steps S1 to S5 are a loop body. It can be seen from the above steps S1 to S5 that, each round of circulation of the method may issue a control instruction to the cooling system 300 and the heating system 400 once, and the control instruction may be a turn-off instruction or a turn-on instruction. In order to avoid frequent start and stop operations of the cooling system 300 and the heating system 400, in the present embodiment, a certain time interval is set between each round of circulation. The time interval is the waiting time to in step S6. Here, the time interval is the same as to in the condition of t<t0 in step S5.

The working principle of the embodiments of the disclosure is as follows:

According to the foregoing formula:

$$dt = \frac{dT}{- c ( T - {T}_{0} )} ;$$

for the two cases of T>T₀ and T<T₀, indefinite integral is performed on the both sides to respectively obtain:

$$t = \int \frac{1}{- ck ( T - {T}_{0} )} dT = \frac{1}{- ck} ln ( T - {T}_{0} ) + C$$

$$and$$

$$t = \int \frac{1}{- c ( T - {T}_{0} )} dT = \frac{1}{- ck} ln ( {T}_{0} - T ) + C$$

The above formulas are converted to respectively obtain:

T=e^{-ck(t-C)}+T₀ and. T=T₀−e^{-ck(t-C)}.

The above formulas can be simplified into:

T=me^{-ut}+T₀ and T=T₀−ne^{-ut}.,u=ck.

T₀ is replaced with Te for substitution, and when t=0, T=Tc is substituted to obtain m=Tc−Te and n=Te−Tc, and then the two formulas may be unified into:

T=(T_{c}−Tₑ)e^{-ut}+Tₑ

Thus, in the natural heat dissipation or heat absorption state, the battery temperature reaches the temperature T₀=(Tc−Te)e^{-uto}+Te from the current battery temperature after the time t0.

In step S5, t<t0 represents that, in response to that Tc>Te, then T₀<Te+Th, that is, (Tc−Te) e^{-uto}<Th; in response to that Tc<Te, T₀>Te−Th, that is, (Te−Tc)e^{-uto}<Th. The two formulas are merged to obtain: dT<Th*e^{uto}, dT=abs(Te−Tc). That is, in theory, step S5 is equivalent to judging whether the temperature difference between the predicted air temperature Te and the current battery temperature Tc is less than a threshold value Th*e^{uto}, and the heating or cooling is stopped if the temperature difference is less than Th*e^{uto}. However, as in the previous experimental data, there is a relatively large difference between the theoretical situation and the actual situation.

The technical effects of the embodiments of the disclosure are as follows: in the embodiments of the disclosure, by means of predicting the air temperature, calculating natural heat dissipation and heat absorption times, adjusting the heating or cooling rhythm of the battery, and reducing the turn-on and turn-off frequency of the heating system and the cooling system, the energy consumption for heating or cooling the battery is reduced while ensuring that the user can use the vehicle at any time.

In addition, the device involved in the embodiments of the disclosure is a virtual device corresponding to the foregoing method, and a component included therein is a step corresponding to the method, therefore details are not described again.

1. A method for thermal control of a battery after charging based on air temperature prediction, comprising the following steps:
step S1: acquiring a current battery temperature;
step S2: judging whether the current battery temperature is within an optimal working temperature section; in response to that the current battery temperature is not within the optimal working temperature section, controlling a heating system to heat the battery or controlling a cooling system to cool the battery, and in response to that the current battery temperature is within the optimal working temperature section, executing step S3;
step S3: acquiring a predicted air temperature of a local area via a network;
step S4: in response to that the predicted air temperature is within a normal working temperature section, stopping heating or cooling the battery, and in response to that the predicted air temperature is not within the normal working temperature section, calculating a duration t required for the battery temperature to reach a target battery temperature from the current battery temperature in a natural heat dissipation or heat absorption state to satisfy, wherein a temperature difference between the target battery temperature and the predicted air temperature being less than Th, Th represents a preset temperature threshold value, an upper limit of the normal working temperature section is greater than an upper limit of the optimal working temperature section, and a lower limit of the normal working temperature section is less than a lower limit of the optimal working temperature section;
step S5: in response to that t<t0, stopping heating or cooling the battery, and in response to that t≥t0, heating or cooling the battery; wherein, t0 represents a preset time threshold value; and
step S6: repeatedly executing steps S1 to S5.

2. The method for thermal control of the battery after charging based on air temperature prediction as claimed in claim 1, wherein in the step S6, the steps S1 to S5 are repeatedly executed after waiting for a certain time interval.

3. The method for thermal control of the battery after charging based on air temperature prediction as claimed in claim 2, wherein in the step S6, the waiting time interval is t0.

4. The method for thermal control of the battery after charging based on air temperature prediction as claimed in claim 1, wherein in the step S4, the time t is calculated by using the following formula:
t=a×In(dT)+b; wherein,
t represents the time required for the battery temperature in the natural heat dissipation or heat absorption state to satisfy the temperature difference between the current battery temperature and the predicted air temperature being less than Th;
dT=abs(Te−Tc);
a and b represent pre-measured coefficients;
Tc represents the current battery temperature; and
Te represents the predicted air temperature.

5. The method for thermal control of the battery after charging based on air temperature prediction as claimed in claim 1, wherein in the step S3, the air temperature prediction data of the local area in the future N hours is acquired via the network, and then the predicted air temperature is obtained by calculating an average value of the air temperature prediction data.

6. A device for thermal control of a battery after charging based on air temperature prediction, comprising the following components:
a component M1, configured to acquire a current battery temperature;
a component M2, configured to judge whether the current battery temperature is within an optimal working temperature section; in response to that the current battery temperature is not within the optimal working temperature section, control a heating system to heat the battery or control a cooling system to cool the battery, and in response to that the current battery temperature is within the optimal working temperature section, execute a component M3;
the component M3, configured to acquire a predicted air temperature of a local area via a network;
a component M4, configured to in response to that the predicted air temperature is within a normal working temperature section, stop heating or cooling the battery, and in response to that the predicted air temperature is not within the normal working temperature section, calculate a duration t required for the battery temperature to reach a target battery temperature from the current battery temperature in a natural heat dissipation or heat absorption state to satisfy, wherein a temperature difference between the target battery temperature and the predicted air temperature being less than Th, Th represents a preset temperature threshold value, an upper limit of the normal working temperature section is greater than an upper limit of the optimal working temperature section, and a lower limit of the normal working temperature section is less than a lower limit of the optimal working temperature section;
a component M5, configured to in response to that t<t0, stop heating or cooling the battery, and in response to that t≥t0, heat or cool the battery;
wherein, t0 represents a preset time threshold value; and
a component M6, configured to repeatedly execute the components M1 to M5.

7. The device for thermal control of the battery after charging based on air temperature prediction as claimed in claim 6, wherein in the component M6, the components M1 to M5 are repeatedly executed after waiting for a certain time interval.

8. The device for thermal control of the battery after charging based on air temperature prediction as claimed in claim 7, wherein in the component M6, the waiting time interval is t₀.

9. The device for thermal control of the battery after charging based on air temperature prediction as claimed in claim 6, wherein in the component M4, the time t is calculated by using the following formula:
t=a×In(dT)+b; wherein,
t represents the time required for the battery temperature in the natural heat dissipation or heat absorption state to satisfy the temperature difference between the current battery temperature and the predicted air temperature being less than Th;
dT=abs(Te−Tc);
a and b represent pre-measured coefficients;
Tc represents the current battery temperature; and
Te represents the predicted air temperature.

10. The device for thermal control of the battery after charging based on air temperature prediction as claimed in claim 6, wherein in the component M3, the air temperature prediction data of the local area in the future N hours is acquired via the network, and then the predicted air temperature is obtained by calculating an average value of the air temperature prediction data.

11. A battery management system for an electric vehicle comprising: a processor, a battery array, a cooling system, a heating system and a mobile communication module,
the processor connecting with the battery array, the cooling system, the heating system and the mobile communication module;
the battery array being formed by connecting several batteries in a battery box;
the cooling system is configured to generally utilize a liquid cooling mode for cooling the batteries in the battery array;
the heating system is configured to generally utilize a PTC (Positive Temperature Coefficient) heating resistor for heating the batteries in the battery array;
the mobile communication module is configured to access a mobile network in a mobile communication mode to connect to the Internet;
the processor is in a battery management unit in the battery box, and configured to implement battery management by executing a computer program instruction set stored on a memory.
